(19) United States
(12) Patent Application Publication
(10) Pub. No.: US 2006/0105230 A1
(43) Pub. Date: May 18, 2006

(54) Automated battery watering control system

(76) Inventor: Johan Fitter, Bryanston (ZA)

Correspondence Address: WILLIAM J. SAPONE;COLEMAN SUDOL SAPONE P.C., 714 COLORADO AVENUE, BRIDGE PORT, CT, 06605, US

(21) Appl. No.: 11/274,359

(22) Filed: Nov. 15, 2005

Related U.S. Application Data
(60) Provisional application No. 60/629,183, filed on Nov. 17, 2004.

(30) Foreign Application Priority Data
Nov. 18, 2004 (AU) 2004 906571

(51) Int. Cl. H01M 10/44

(52) U.S. Cl. 429/61; 429/63; 429/50

(57) ABSTRACT

The invention is an automated single point battery watering system which has a battery watering control system comprising a fluid reservoir, a fluid delivery header for delivering fluid from the reservoir to the cells of at least one battery, a flow controller in communication with the fluid delivery header for controlling the flow of fluid from the reservoir through the header, and a monitoring system for monitoring the battery charge state and for timing the activation of the flow controller for adjusting the flow relative to the state of charge so that over watering does not occur. Also included is a fluid restrictor associated with the fluid delivery system to limit gas flow into the fluid delivery header.

### CROSS REFERENCE TO RELATED APPLICATION

This application claims priority in U.S. Provisional patent application No. 60/629,183 filed Nov. 17, 2004.

### BACKGROUND OF THE INVENTION

This invention relates to a filling system for adding replenishment water to one or more secondary batteries, each typically comprising multiple cells, and more particularly, to an automated battery watering control system that monitors and senses whether a battery is in condition for watering.

Secondary battery cells, for example, lead-acid battery cells, have a liquid or flowable electrolyte that requires periodic replenishment of water lost from the electrolyte through electrolysis and evaporation.

The process of adding water can be simple when the number of batteries and the number of battery cells is small, and there is available manpower. However, it is increasingly common for some facilities to have tens or even hundreds of batteries in use. The number of individual cells that must be periodically filled is thus quite large. To meet this need, single point battery watering equipment is available which can be set up as a watering station where multiple batteries can be located and filled at the same time. Such equipment usually has a large reservoir and means for dispensing fluid to the multiple battery cells.

In facilities having a large number of batteries, it is common for individual batteries to be in different states of discharge at any given time, due to differences in usage, age or other factors. Thus, some batteries will require recharging before others, which makes scheduling recharges somewhat difficult.

Another problem is that batteries, such as lead-acid batteries, cannot be watered when they are at a low state of charge since the electrolyte expands on charging. If filled during a low state of charge, subsequent charging can cause the electrolyte to attain an excessively high level, with electrolyte overflowing the cells. As the electrolyte is typically sulfuric acid, such overflows must be minimized to avoid damage to adjacent structures.

Consequently, the logistics of providing water to many batteries that are in a variety of states of charge throughout the working day can be difficult, even with use of single point battery watering equipment.

These problems may be reduced, though not eliminated, by using a watering controller which operates in conjunction with the battery charger. Such a controller provides water to the battery automatically when the battery state of charge is sufficiently high.

Although intended to free battery operators from being in attendance during the battery watering operation, in practice, such a control strategy was often found to provide the batteries with more water than was needed. In addition, the associated watering systems became so complicated that an operator was still required to monitor watering and to occasionally intervene to avoid overwatering or overflows.

For example, if a battery had not been used between watering cycles, and was then connected to the system, the battery would receive water since it was still in a charged state, even though no water was in fact needed, resulting in double watering. This was because the water addition system was activated at about 80% state of charge, apparently chosen to take advantage of gassing that occurs when charging at that state to mix the water with the electrolyte. Unfortunately, this simply put more water into a cell having an already high level of electrolyte, with further expansion during charging resulting in an electrolyte overflow.

Another problem can occur should the water reservoir run dry, which could also leave the water distribution tubing mounted atop the battery cells dry as well, thereby allowing the tubing to act as a conduit for gas evolving in the battery, which could lead to hydrogen gas accumulation in the tubing and reservoir.

While watering controllers provide an opportunity to charge and add water to batteries overnight and over weekends, completely unattended, as described above, such inattention can lead to electrolyte spillage and/or gas filled tubing necessitating corrective action and cleanup. Consequently, most users of these systems have not been willing to risk such occurrences, and require an operator to be present to monitor the filling process.

### SUMMARY OF THE INVENTION

It is an object of the present invention to provide a battery watering control system which avoids the above referenced problems.

It is a further object of the present invention to provide a battery watering control system which can truly be run successfully with little to no operator attention.

It is yet another object of the present invention to provide a battery watering control system which substantially avoids overwatering.

It is another object of the present invention to provide a battery watering control system that minimizes the possibility for battery gas to enter the watering system.

These and other objects of the present invention are achieved by a battery watering control system comprising a fluid reservoir, means for delivering fluid from the reservoir to at least one battery, flow control means in communication with the conduit means for controlling the flow of fluid from the reservoir through the delivery means, and means for monitoring the battery charge state and for timing the activation of the flow control means relative to the state of charge such that overwatering does not occur.

### BRIEF DESCRIPTION OF THE DRAWINGS

FIG. 1 is a view of the battery watering control system of the present invention.

FIG. 2 is a cross-sectional view of the portion of the delivery system located in a battery watering opening.

FIG. 3 is a view showing the battery receiving water from the watering control system.

FIG. 4 is a view showing the battery watering system by-passing a filled battery cell.

FIG. 5 is a view showing the battery watering system after completion of the watering operation.

FIG. 6 is a schematic view of a control diagram usable with the present invention.

FIG. 7 is a graph showing percent electrolyte expansion relative to the volts per cell.

### DETAILED DESCRIPTION OF THE INVENTION

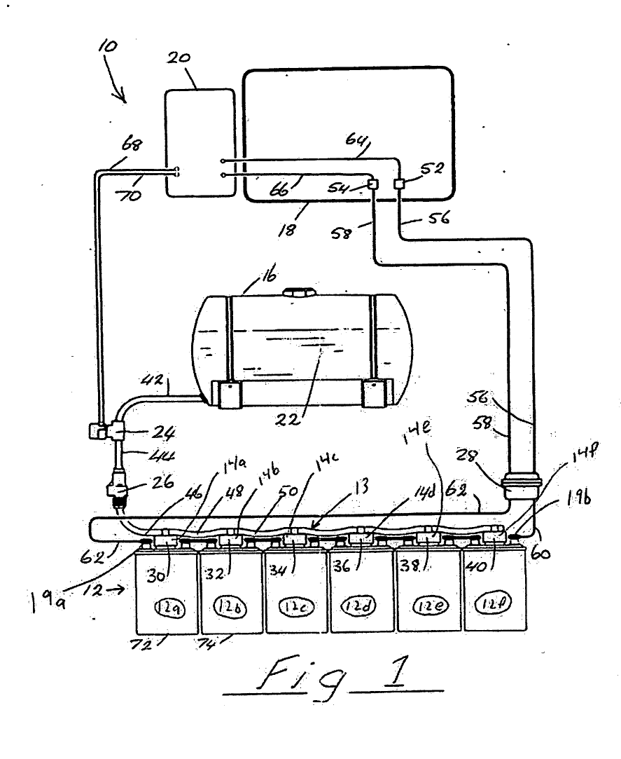

FIG. 1 is a schematic representation of the control monitored single point battery watering system 10 of the present invention. A battery 12 has, by way of example, six cells 12a-f, the battery 12 fitted with a plurality of water flow-control caps, 14, interconnected by a header 13, as will be described in more detail below. The number of caps will correspond to the number of cells to be filled, and these can be arranged to fill multiple batteries at the same time, tailored to the needs of the facility where the system is located. Six cells is chosen merely for convenience and to simplify the discussion and drawings, as would be understood by one skilled in the art, as the system can easily be scaled up to supply battery water to virtually any number of cells.

The watering system 10 has a water source or reservoir 16 that contains a fluid for delivery to the battery cells. It should be understood that the fluid may be water alone or include suitable additives, and the terms “water” or “watering”, are not limited to solely water as the fluid to be administered.

A battery charger 18 is connected to battery terminals 19a and 19b for recharging the battery 12. A watering controller 20 controls the delivery of the fluid to the battery 12. Preferably the fluid is delivered following charging of the battery to a selected level of electrical charge, as will also be described further below.

The watering system 10 has a flow control valve 24 which is preferably an electrically operated normally closed solenoid valve. In this embodiment, a fluid coupling 26, which may be a quick connect coupling, threaded coupling, etc., is used to connect the valve 24 to the header 13 feeding the flow control caps 14. An electrical coupling 28 may be used to connect the charger 18 to the battery terminals. For example, any male/female electrical connector suitable for use with the voltages/amps involved can be used. Such connectors allow the system to be quickly associated with different batteries.

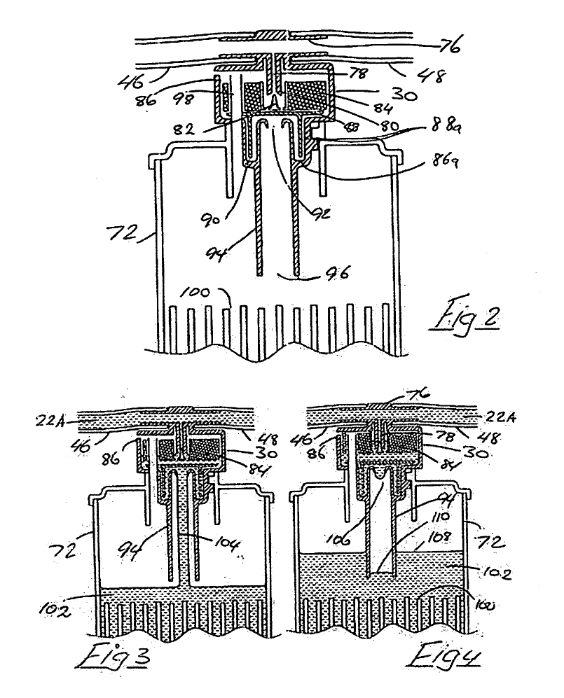

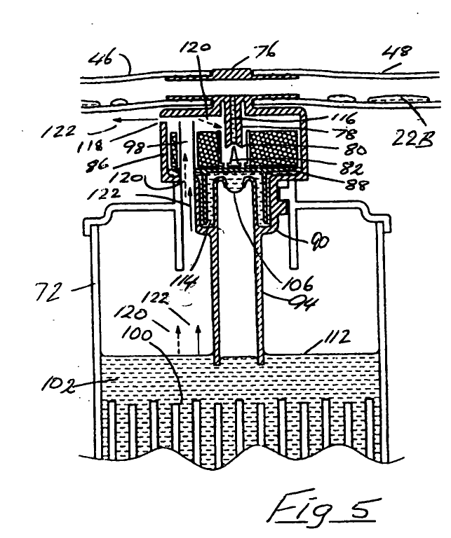

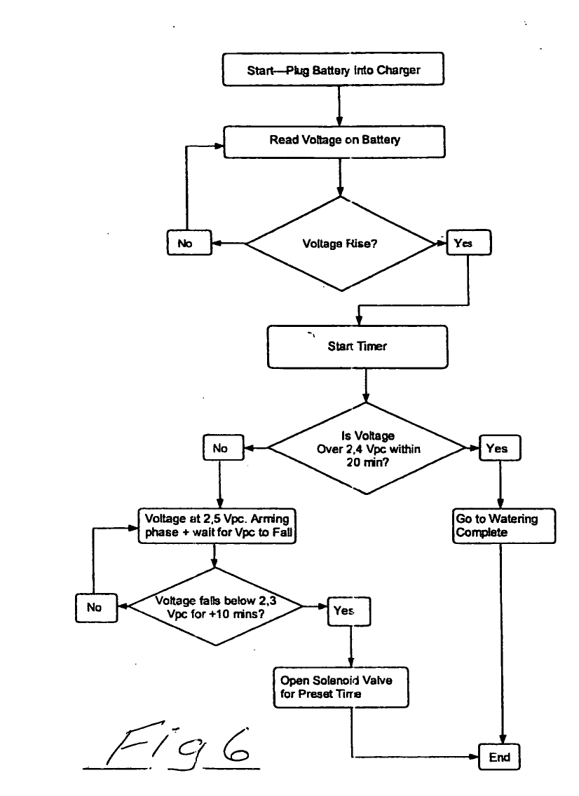

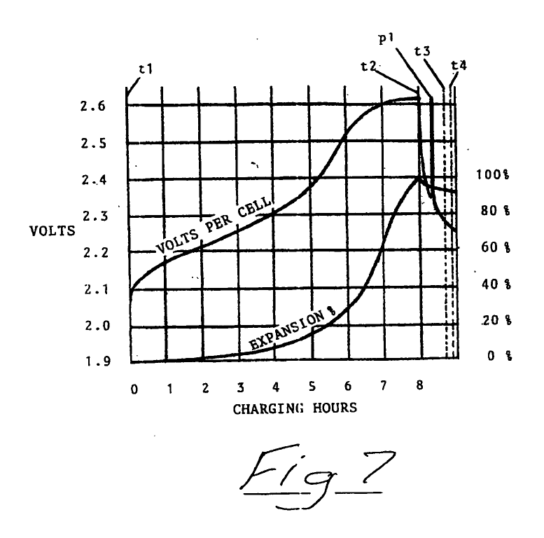

The flow through the water flow-control caps 14 is illustrated in FIGS. 2, 3, 4 and 5, as will be described further below. These are arranged to provide self-priming water barriers which form an important part of the control monitored single point battery watering system 10 of the invention.

The battery 12, the water reservoir 16, the battery charger 18, the solenoid valve 24 as well as the two couplings 26 and 28 are all of a type well known to persons skilled in the art and therefore require only a brief explanation here. However, the watering controller 20 contains unique operational aspects that in conjunction with the water flow-control caps 14 provide a system that can truly be run, reliably, unattended, thereby facilitating battery charging and watering in off-hours or on off days, reducing operating costs while increasing efficiency. Further, by limiting overflows and electrolyte spills, and reliably providing the proper amount of water to the batteries over the life of the batteries, that life itself may be extended. It is well know that a proper battery watering schedule can prolong battery life and the system of the invention makes this much more likely to occur.

The battery 12 has six cells, as shown in FIG. 1, each cell being fitted with an individual water flow-control cap annotated in a sequence as 30, 32, 34, 36, 38 and 40. The water flow-control caps are connected in series by the fluid header 13, though they may also be connected in parallel or in a series-parallel combination. In this embodiment, the coupling 26 is connected to the cap 30 by a length of tubing 46, the cap 30 connected to the cap 32 by a length of tubing 48, the cap 32 to the cap 34 by another length of tubing 50, etc, sequentially to the end cap 40, beyond which the fluid header is closed.

The tubing 46 has a length sufficient to provide ease in the connection and disconnection of the header 13 to the coupling 26. The battery 12 is connected to the electrical coupling 28 by a pair of cables 60 and 62, or by a single cable with two conductors therein, the cables being movable to another battery after the battery 12 has been charged and replenished.

The water reservoir 16 is preferably positioned above the battery 12 to provide gravity flow to the battery 12, though gravity feed is not the only way of supplying the fluid to the header, such as by use of a pump, though gravity feed has the advantage of reliability and low cost.

A fluid conduit 42 is provided between the water reservoir 16 and the first of the water flow-control caps 30. The solenoid valve 24 and the fluid coupling 26 are integrated with the conduit, to complete the water supply circuit.

The battery charger 18 has a pair of terminals 52 and 54 connected to cables 56 and 58 which conduct the charger output current to the battery 12 via the electrical coupling 28, with a polarity and magnitude suited to the battery 12.

The fluid coupling 26 and the electrical coupling 28 connect and disconnect independently. They may, however, be integrated into a single assembly for ease in attachment to the battery. Preferably, the open ends of the fluid conduits exposed when the fluid coupling 26 is disconnected have self-closing barriers, which close when the fluid coupling 26 is disconnected, and which open when it is connected. These barriers may be fitted to one or both sides of the fluid coupling 26.

The electrolyte level of an industrial motive power flooded-type lead-acid battery rises significantly towards the end of charge, and an addition of replenishment water to a discharged battery that appears to be a correct level can result in the level rising to a point of overflowing when the battery is subsequently charged.

The battery control scheme which utilizes a monitoring controller is next described. As discussed above, to avoid any risk of overflowing, and of corrosive acid spills, the battery should only be replenished when the electrolyte has attained a maximum level, which occurs at the end of the charging process.

The voltage of a lead-acid battery on charge rises very slowly from a fully discharged state, to about 80 percent. Approaching 100 percent state-of-charge, the battery voltage can increase from 2.35 volts per cell, to 2.6 volts, and even 2.8 volts per cell. A voltage in excess of 2.35 volts per cell causes the battery to gas, and an accumulation of gas bubbles can occur below the level of the electrolyte which raises the electrolyte level significantly. Other factors that contribute to raising the electrolyte level are chemical—there is more acid in a charged battery- and thermal—the process of charging warms and expands the electrolyte.

Upon cessation of charging the battery voltage declines fairly rapidly from its on-charge potential to its rest potential. The change is most pronounced when the battery is at a full state-of-charge.

The watering controller 20 has means to monitor the voltage of the battery 12 via a pair of sensing leads 64 and 66, connected at the battery charger terminals 52 and 54, which carry the voltage of the battery 12 during the charging process. In one embodiment of the invention, the battery charger 18 and the watering controller 20 can be physically and/or functionally combined in a unitary housing.

One way to integrate the detection of the cessation of charging with the watering controller 20 is to detect a substantial voltage declination across the pair of terminals 52 and 54, due to a power rectification process within the battery charger 18, and to issue a signal to the flow control valve to open and supply fluid only when that point is reached. Preferably, the monitored voltage is processed by an averaging circuit before being utilized by the watering controller 20.

The watering controller 20 needs to open the valve only for a period of time sufficient to replenish the battery 12. For example, in the case of a medium sized forklift battery, as used in a warehouse, the requirement is likely to be for about 200 milliliters of replenishment water per cell per working week. Since the battery is likely to be charged daily, an 18 or 24 cell battery will need up to a liter of water per daily cycle. Consequently, the appropriate watering time should be set in the watering controller.

Another factor to consider in the watering time is that it is a characteristic of all secondary batteries that they require more energy to be put in than was previously taken out. Consequently, battery chargers are arranged to provide a degree of overcharging, which can vary according to the type of charging equipment, depth of discharge of the battery, temperature and many other factors. Consequently, the replenishment requirement of a battery may vary quite significantly, requiring an adjustment of the determined opening time of the valve 26.

One problem that can occur is that power interruptions and brownouts can provide false end-of-charge signals. Also, disconnection of a battery prior to attaining a 100 percent state-of-charge can result in insufficient watering. Furthermore, attempting to charge a battery, already at, or near 100 percent state-of-charge can provide excessive watering. Moreover, certain types of battery chargers apply a succession of current pulses following termination of charging, causing the battery voltage to rise and fall significantly. This succession of pulses can result in repeated, inadvertent watering.

The watering controller 20 of the present invention is capable of obviating these disadvantages, by using a monitoring system that can detect these “false” watering conditions, and thereby prevent water flow. While the watering controller 20 can be constructed from discrete electronic functional units, for example, logic gates, counters, etc. it is preferred to use a microprocessor architecture to incorporate the monitoring system of the invention, and it is possible to implement this by way of a software and/or hardware solution. For example, some or all of the functions can be provided on a programmable chip, and the invention is not limited to any one particular means for providing the monitoring system of the invention.

FIG. 6 depicts a logic diagram that may be used in a typical embodiment of the invention. Generally, this begins after the battery is attached to the charger, and the filling apparatus has been properly located for filling the individual cells. After this occurs, the controller is powered up. The sequence commences with pressing a start button or by receiving a command to begin. After Start, the watering controller 20 proceeds to Read Voltage on Battery 12. If the battery charger 18 is not immediately switched on, the Voltage Rise? will not occur, and register No, returning the system to Read Voltage on Battery. When the charger 18 is switched on, there will be a rise in voltage, and so the query response to Voltage Rise? will switch to Yes, and the controller will proceed to Start Timer.

The watering controller 20 continues to monitors the rise in voltage due to the battery 20 being charged by the charger 18 over a specified time period, for example, within 20 minutes of commencement of charging. This provides a damping period to avoid improper watering. If the Is Voltage Over 2.4 Vpc within 20 min? query is answered Yes, no watering is undertaken. This is because if the battery 12 when connected is already fully charged, the rise in voltage per cell will exceed 2.4 V. within 20 minutes of charge initiation. In such a case, no watering should be undertaken. If the battery is low on charge, i.e. been discharged, but not over discharged, its voltage per cell should lie somewhere between 2.1 and 2.3 volts, in accordance with the volts per cell curve in FIG. 7, depending on the number of charging hours remaining to bring it up to a full state of charge. Note that the information presented in FIG. 7 represents a taper charge at a temperature of 15° C.

If the battery 12 has been over discharged, any addition of water will further dilute the electrolyte and make it more difficult for the battery to accept charge. However, such a battery will also display a rise in voltage that exceeds 2.4 V per cell within 20 minutes of charge initiation, and so the watering controller 20 “sees” the battery 12 as already charged, and will not initiate the watering sequence.

If there is a voltage rise above 2.4 v per cell within 20 minutes, the controller 20 receives a Yes response, and by-passes the watering sequence and terminates by the Go to Watering Complete and End steps. Note that this condition also addresses the situation where the battery may have become prematurely unplugged. When this happens, the battery 18 may be “offered” another opportunity to accept water during the course of the next charging operation. Since the system can determine whether a battery has already been charged, there is no harm in re-checking the battery status periodically to determine if further charging is appropriate.

If the voltage per cell remained under 2.4 for 20 minutes, the controller 20 proceeds via No to the watering arming phase. This has two steps. First, it monitors the voltage to see if it reaches 2.5 V per cell, and then it waits for the voltage to fall. This is what occurs when the battery is at about 80% of charge. Then when the voltage per cell falls below a threshold level, for example, 2.3 V for about 10 minutes, this indicates that the charging is complete, and so watering can safely begin. Thus, the controller monitors voltage and when the Voltage at 2.5 Vpc. Arming phase+wait for Vcp to Fall is achieved and the Voltage falls below 2.3 Vpc for +10 mins? answer is Yes, then the controller issues a signal for watering to begin by opening the flow control valve.

Thus the end of charge is recognized by the controller 20 when the volts per cell exceeds 2.5 V and then begins to fall. If the volts per cell does not go over 2.5 V and yet the volts per cell begins to fall, the controller 20 perceives this as a possible power outage or brownout, and watering will not begin. This allows the charger 18 more time to complete its task.

When the voltage per cell falls after attaining 2.5 V, the control sequence will continue to circulate via No and Voltage at 2.5 Vpc. Arming phase+wait for Vpc to Fall and Voltage Falls below 2.3 Vpc for +10 mins? Eventually the voltage per cell does fall below 2.3 V for 10 minutes and the sequence switches to Open Solenoid Valve for Preset Time via Yes. This preset time period corresponds to the timing interval that the flow control valve is open, such as when the electrically operated normally closed solenoid valve is energized, and a portion of the water 22 is permitted to flow from the reservoir 16 to the cells of the battery 12.

If the charger 18 should provide a form of end-of-charge pulsing, causing the potential of the battery to vary up and down, each successive rise in potential causes the Voltage falls below 2.3 Vpc for +10 mins? sequence to default to No and therefore watering will not be permitted until at least 10 minutes following the last pulse.

This aspect has been shown occurring once, as a voltage spike or charging pulse p1 on the volts per cell curve during the interval t2 to t3 in FIG. 7. While only one pulse has been shown in FIG. 7, it is usual for pulsing to be repeated. These repeats have not been shown for the sake of clarity of the illustration.

FIG. 7 also shows an electrolyte expansion curve expressing the percentage between minimum and maximum level of the electrolyte due to the charging process, a difference which can exceed 50 millimeters in respect of the tallest industrial cells currently in use.

While there is a widely held belief that watering after charge is best avoided since it can lead to stratification of the water above the electrolyte, this belief only applied from the days when it was common for batteries to be watered infrequently and therefore the sheer volume of water being added naturally took a long time to mix with the rest of the electrolyte. This does not apply to watering after every successive charge since the amount of water then being added will be so small as to mix practically instantaneously. Nevertheless, the typical control strategy in automatic watering systems in use today is still to water the batteries before the end of charge, in line with the proposed embodiment of U.S. Pat. No. 4,359,071.

However, the inventor has determined that this is not the optimum control strategy, as watering the tallest cells before the end of charge, with reference to the expansion curve shown in FIG. 7, if done 1½ to 2 hours before charge completion, would likely provide about 30 millimeters over and above the normal electrolyte level and this could push some of the electrolyte out of the cells upon attainment of full state of charge.

The present invention takes advantage of the falling level of the electrolyte, as illustrated in FIG. 7, upon cessation of charging. According to the invention, the timing interval t3 to t4 corresponds to the duration the water 22 is applied to the battery 12, the timing interval t1 to t2 corresponds to the duration of charging the battery 12 by the charger 18, and the timing interval t2 to t3 corresponds to the delay after charge completion before commencement of watering.

Overwatering due to attempted charging of an already fully charged or nearly fully charged battery is prevented by the control sequence Voltage Rise?—Yes—Start Time—Is Voltage Over 2.4 Vpc within 20 Min?—Yes as illustrated in FIG. 6. With reference to FIG. 7 the sequence Voltage Rise? go to Yes corresponds to t1—the commencement of charging and the sequence Start Timer—Is Voltage Over 2.4 Vpc within 20 min? go to Yes corresponds to a routine that detects the battery 12 as being already fully charged or nearly fully charged at the time of its connection to the charger 18 corresponding to Start-Plug Battery Into Charger. Detection of an already charged condition of the battery 12 is made possible through a characteristic of the type of battery in use, which causes the voltage of the cells to rise very quickly upon application of a suitable charging current, occurring, for example, within a 20 minute time period from start of charging, as permitted by Is Voltage Over 2.4 Vpc within 20 mins? More specifically, it corresponds to a period of detection from t1 to t1+20 minutes, (or any other suitable timing interval).

A problem facing the battery maintenance industry has been a growing preference for more compact battery construction. This may be achieved by reducing the available headroom or space above the electrolyte and below the cell lids. Of course, this restricts the volume available for electrolyte expansion. Thus, watering before end of charge poses an increased risk of overfilling when using the prior automatic watering systems, requiring more frequent operator oversight when such compact batteries are used.

The change in control strategy of the present invention, watering after t2, is a significant step towards achieving automated watering, even of these compact batteries, without operator intervention.

Another improvement is the use of a control strategy that detect if a battery already is in a high state of charge, by monitoring a comparatively rapid voltage rise soon after the battery has been put on charge, during the period of t1 to t1 plus a suitable timing interval.

Furthermore, the inventive control system eliminates power outages and brownouts as false signals that watering is required, allowing watering to be delayed.

The inventive control system also uses voltage monitoring to detect an end of charge, which provides an effective battery watering signal, typically interval t3 to t4, following the last of n charging periods, of which at least one period constitutes the bulk of the charge.

In conjunction with the novel control system, there is used a preferred cell filling system which improves reliability for the distribution system, thereby rendering it more likely that the system can run unattended. This relates to the use of a water sealing or gas flow obstruction arrangement integrated with the water flow-control caps located on the battery 12.

Generally, comparatively narrow bore tube portions are used on the inlet and outlet sides of each water flow control cap, which are of such a diameter that a quantity of fluid is retained therein by capillary action. This has not been found to be an impediment to water flow and feed to the cells, but when the flow stops, instead of draining out, water is retained within the tubing portions which surprisingly provides an effective barrier to a flow of gas effluent from the battery cells into the water feed or fluid conduits associated with the water flow-control caps. In such a case, there is significantly less risk from unattended operation, for example, if the reservoir runs dry, as the fluid retained in the tube sections keeps any gas effluent sealed in the battery. These capillary sections provide an effective contribution towards safety and reliability, and in conjunction with the control system of the invention, in particular, towards achieving a truly unattended battery watering operation.

FIG. 2 shows a schematic section of the water flow-control cap 30 located on an associated battery cell 72, which for clarity only, are shown temporarily without any water and without any electrolyte. The cap 30 is generally similar to a battery filler unit described in U.S. Pat. No. 4,544,004 to Fitter et al, the disclosure of which is incorporated herein by reference in its entirety.

The cap 30 is connected to the tubing 46 and 48 by means of a tee 76, communicating with an antechamber-like fluid conduit comprising a downwardly projecting tube 78 and connectable to a valve arrangement or valve seat 80. A concentric valve 82 comprising an outer sleeve and an inner cone, connected by a support bridge, is located within a float 84 which is made of a closed cell foamed plastic to provide buoyancy in water. The valve 82 and the float 84 are located within a cup-like enclosure with lid 86, and the float 84 is shown resting on a plate 88 having a downwardly projecting wall 88a which forms a water trap 90 in conjunction with concentric base walls 86a of the cup-like enclosure 86. The inner base wall 88a of the cup-like enclosure 86 extends downwardly to form a vertical level sensing tube 94 having a flanged orifice or aperture 92 at its top, and an open mouth 96 at its bottom. The cap 30 includes a breather tube 98 which permits passage of any effluent gases emanating from the region of a set of electrodes 100 to the exterior of the cap 30.

In operation, water emerging from the downwardly projecting tube 78 will continue downwards, past the cone of the valve 82, and hence under the float 84, and if sufficient water accumulates, will provide an upthrust by means of flotation so as to drive the cone of the valve 82 towards closing of the valve seat 80. The plate 88 is fixed in position, and will allow a portion of the incoming water to flow immediately via the water trap 90 and the aperture 92, down the center of the level sensing tube 94, into the cell 72 below.

This is more fully illustrated in FIG. 3, which shows the battery cell 72 containing an electrolyte 102 receiving a stream of water 104 from the cap 30, for example, when the watering controller 20 has energized the solenoid 26 and water 22 is permitted to flow via the fluid conduit to fill the lengths of tubing 46 and 48, the tee 76 and the downwardly projecting tube 78 with a volume of water 22A.

The flow of water 104 out of the aperture 92 drains a portion of the water 22A that might otherwise accumulate in the cup-like enclosure 86, and thus deprives the float 84 of a full extent of buoyancy—at least until the water 104 ceases to flow. Consequently, the float takes up a position that results in narrowing, by closing the valve 82 against the valve seat 80.

In FIG. 4, the electrolyte 102 has risen to a level 108 which is sufficient to increase air pressure inside the level sensing tube 94 to cause the water flow to be arrested and to form a substantially static drop 106 in its place. The float 84 quickly rises to close the valve 82 against the valve seat 80.

The various tubes and flow paths, including the tubing 46 and 48, the tee 76 and the downwardly projecting tube 78, contain residual water 22A, as shown in FIG. 4 and this can provide a barrier against gas entering the watering system 10.

FIG. 5 shows the water flow-control cap 30 located on a cell 72, corresponding to the cap and associated cell in FIG. 1. The next-in-line cap 32 is located on an adjacent cell 74, as shown in FIG. 1.

The battery 12 in FIG. 5 has been in use, and consequently the electrolyte 102 of the cell 72 has fallen to a level 112. Residual water 114 remains in the water trap 90, and an almost negligible amount of water 22B remains inside the lengths of tubing 46 and 48 and the tee 76. Although the valve 82 has withdrawn from the valve seat 80, due to the float having come to rest on the plate 88, the downwardly projecting tube 78 continues to accommodate a plug of water 116 within it.

Upon investigation, this surprising retention of liquid within a vertical tube, though subject to gravity, was found to be due to capillary action, and also found to occur in the caps 32, 34, 36, 38 and 40 of FIG. 1. So strong was this retention that removal of a watering cap from the cell could easily be effected without significantly disturbing the water plug 116. Subsequent rotation of the cap 30 in various directions so as to move the axis of the tube 78 from vertical to horizontal, and back repeatedly, as well as to rotate the axis of the tube 78, appeared to have no detrimental effect on the persistence of the water plug 116 within the tube 78.

It was found that the inner bore diameter of the downwardly projecting tube 78 played an important role in providing retention of the water plug 116, the narrow bore providing good retention, while a wide bore provided poor retention. As a general guide, bore diameter of up to 4 or 5 millimeters appeared to give good retention, while larger bores seemed to lose retention more quickly with increase above these diameters.

Experimentation revealed a variety of tube geometries suitable for use in applications corresponding to the tube 78. For example, a tube having different diameters along its length, differing cross sectional shapes, bends, junctions, as well as multiple flow paths, including a tube with a porous material filling so as to provide multiple capillary passages have been found suitable. Water retention remained satisfactory in all orientations.

In an arrangement including consecutive tube section having different diameters, it was found that the narrower bore section contributed to the persistence of the water plug 116.

While the wetability of the inner bore surface might appear a significant factor in the plug retention, the use of Teflon (PTFE-polytetrafluoroethylene)—a polymer know for its exceptional non-wetting characteristics—provided only a marginally less effective plug, somewhat akin to the use of a wider inner bore diameter.

By way of example, a 30 mm length of PVC tubing, having an inner bore diameter of 3 mm retained a 13 mm length plug in all orientations after being filled with water, a 30 mm length of ABS tubing retained 9 mm, while a similar length of PTFE retained a length of 6 mm.

It is normal for battery cells to emit gas from the region of the electrodes 100 almost continuously, and especially briskly upon attaining a full state of charge. This causes sufficient agitation of the electrolyte 102 to produce an acid mist or spray, a portion of which has been found to project via the breather tube 98 into the cup-like enclosure 86, along a path indicated by a series of dashed arrows 120.

A smaller portion of the acid mist or spray has been found to enter the downwardly projecting tube 78, thereby to sustain, and even to augment the plug of water 116 within the tube 78.

A consequence of the presence of the water plug 116 inside the downwardly projecting tube 78 is to provide an obstruction to passage of gas, from within the cup-like enclosure 86 to the tee 76, and hence into the lengths of tubing 46 and 48, and vice versa. A need to rely on a gas flow preventor to accomplish this function is thereby obviated.

Accordingly, any gas emitted from the region of the electrodes 100 is more likely to follow a path via the breather tube 98, out of the cup-like enclosure 86 and hence to the exterior of the cell 72, through a vent slot 118, generally as indicated by a series of plain arrows 122.

While capable of providing an obstruction within the downwardly projecting tube 78, the water plug does not provide an absolute barrier in the sense of what an impermeable solid object might be expected to provide. It is possible that effects including diffusion and mechanical vibration could assist almost imperceptible quantities of gas originating from within the cell 72, to traverse the obstacle provided by the water plug 116. However, it is likely easier for such quantities to escape from the enclosure provided by the fluid conduit, thereby negating an ongoing buildup.

While the need to rely on a purpose-made gas flow preventor has evidently been obviated, it is feasible by way of supplement to include any variety of devices having an equivalent function.

An electrically initiated single point battery watering system for providing a controlled flow of replenishment water into a battery, preferably including a capillary duct feed system for conveying water to each cell of the battery, has been described.

While particular embodiments of this invention have been described, it will be understood, of course, that the invention is not limited thereto since many obvious modifications can be made, and it is intended to include within this invention any such modifications as will fall within the spirit and scope of the appended claims.

What is claimed is:

1. A single point battery watering control system comprising:
a fluid source;
conduit means for delivering fluid from the fluid source to at least one battery, the conduit means having integrated therewith flow restriction means for retaining a fluid plug therein due to capillary action;
flow control means in fluid communication with the conduit means for controlling a flow of fluid from the fluid source to the at least one battery;
means for monitoring changes in voltage of the battery and for activating the flow control means relative to the monitored voltage rate and/or the state of charge for adding or stopping the fluid flow to the at least one battery, the flow restriction means retaining the fluid plug therein sealingly substantially preventing gas in the battery from entering the conduit means.

2. The battery watering system of claim 1 further comprising a battery charger connectable to the at least one battery, for charging the at least one battery, the monitoring means monitoring the battery voltage rate through the battery charger.

3. The battery watering system of claim 1 wherein the monitoring means monitors a state of charge of the at least one battery.

4. The battery watering system of claim 1 wherein the monitoring means senses changes in battery voltage over time and has means to detect a full state of charge of the at least one battery.

5. The battery watering system of claim 1 wherein the monitoring means has means for timing the activation of the flow control means.

6. The battery watering system of claim 1 wherein the conduit means comprise a fluid addition header having one or more caps locatable on one or more cells of the at least one battery for delivering fluid thereto.

7. The battery watering system of claim 6 wherein the fluid addition header has a plurality of tube sections for interconnecting the one or more caps, one or more of the tube sections being capillary tube sections.

8. The battery watering system of claim 6 wherein the one or more caps contain one or more tube sections which are capillary tube sections.

9. The battery watering system of claim 1 wherein the flow restriction means comprise one or more capillary tube sections.

10. The battery watering system of claim 1 wherein the fluid source is a reservoir adapted to contain the fluid therein

11. A method for automated delivery of a fluid to a least one battery comprising:
connecting a fluid source to the at least one battery using conduit means having flow restricting means integrated therewith which restrict gas from passing therethrough by retaining a fluid plug therein due to capillary action;
controlling the flow of fluid from the fluid source to the battery; and,
monitoring changes in voltage over time of the battery and adding or stopping the fluid flow to the battery based on the monitored voltage charges to avoid over watering.

12. The method of claim 11 further comprising charging the battery and monitoring the state of charge of the at least one battery.

13. The method according to claim 11 wherein the conduit means comprise a fluid addition header having one or more caps locatable on one or more cells of the at least one battery for delivering the fluid thereto.

14. The method according to claim 13 wherein the fluid addition header has a plurality of tube sections for interconnecting the one or more caps, one or more of the tube sections being capillary tube sections.

15. The method according to claim 13 wherein the one or more caps contain one or more tube sections which are capillary tube sections.

16. The method according to claim 11 wherein the flow restriction means comprise one or more capillary tube sections.

17. The method according to claim 11 further comprising providing capillary means for sealingly supplying fluid to the battery.

18. The method of claim 11 further comprising providing a fluid reservoir adapted to contain the fluid therein, the fluid reservoir being the fluid source.
